(19) United States
(12) Patent Application Publication
(10) Pub. No.: US 2010/0301815 A1
(43) Pub. Date: Dec. 2, 2010

(54) ELECTRIC VEHICLE HAVING A GENERATOR

(76) Inventor: Side DAI, Xiamen Fujian (CN)

Correspondence Address: Dr. BANGER SHIA;Patent Office of Bang Shia, 102 Lindencrest Ct, Sugar Land, TX, 77479-5201, US

(21) Appl. No.: 12/476,999

(22) Filed: Jun. 2, 2009

(51) Int. Cl. H02P 9/00

(52) U.S. Cl. 322/24; 903/930

(57) ABSTRACT

An electric vehicle having a generator includes a body, an electric machinery, an electric machinery controller, a battery and a generator. The generator generates electricity to the battery and provides power supply to the electric machinery through the electric machinery controller for driving wheels of the body to advance. The electric vehicle further includes a control system. The control system includes a central processing unit (CPU), a battery voltage detection module to detect a voltage value of the battery and send the voltage value of the battery to the CPU, a comparison module to compare the voltage value of the battery with a preset maximum voltage value and a preset minimum voltage value and send a comparison result to the CPU, a battery output current detection module to detect an output current value of the battery and send the output current value of the battery to the CPU, a generator output voltage detection module to detect an output voltage value of the generator and send the output voltage valve of the generator to the CPU, the CPU being adapted to receive the aforesaid data and analyze for controlling the generator to work and its output status. The present invention ensures that the electric vehicle is able to drive outdoors continually without causing any harmful effect to an electric machinery controller and a battery so as to provide a certain protection to the battery.

### BACKGROUND OF THE INVENTION

1. Field of the Invention

The present invention relates to an electric vehicle, and more particularly to one having an adequate power to drive.

2. Description of the Prior Art

An automobile is convenient for people to go out, but it brings serious air pollution. Scientists in the world pay more attention to solve this problem. Looking for a new power source for an automobile becomes a top priority. An electric vehicle has been used widely, such as a motor-driven bicycle, a motorcycle, a sightseeing vehicle or a golf cart which uses a battery as a power source.

However, the electric vehicle uses a battery which is able to be charged for providing electricity to run the electric machinery and drive wheels. Because the size of the electric vehicle is limited, the size of the battery is also limited. Thus, the stored electricity of the battery is restricted. The battery needs to be charged frequently. Sometimes, the battery may run out on the way, and the electric vehicle has to be pushed. This is very inconvenient. Even if the battery set has remnant electricity, it will slow down the vehicle. That lowers the speed to drive a vehicle and shortens the service life of the battery.

FIG. 1 shows a Chinese Utility Model Application No. 200820031720.4 titled “a small-scale direct current generator sets”, which comprises an internal combustion engine 10, a direct current generator 40, a power supply switch 70, and an electric vehicle power battery set 60. The internal combustion engine 10 is connected to the direct current generator 40 through a connecting shaft 20. A positive terminal 30 of the direct current generator 40 is connected to the positive pole of the electric vehicle power battery set 60 through the power supply switch 70. A negative terminal 50 of the direct current generator 40 is connected to the negative pole of the electric vehicle power battery set 60. When the electric vehicle power battery set 60 runs out or is not enough, the internal combustion engine 10 will be started to drive the connecting shaft 20 which brings the direct current generator 40 to turn synchronously. The direct current generator 40 starts to generate electricity and the power supply switch 70 is closed so that the electric vehicle power battery set 60 is to be charged for running the electric machinery and insuring the electric vehicle to keep going.

However, when the aforesaid structure is in use, the direct current generator 40 continuously generates electricity to the electric vehicle power battery set 60 after the power supply switch 70 is closed. The direct current generator 40 generates instable voltage and current to the battery set 60 and then into the electric machinery, which makes the voltage of the electric machinery instable. This shortens the service life of the electric machinery. In addition, the internal resistance of the battery set 60 is smaller, and the direct current generator 40 direct outputs electricity to the battery set 60. This may damage the battery set 60. Accordingly, the inventor of the present invention has devoted himself based on his many years of practical experiences to the development of an electric vehicle having a generator.

### SUMMARY OF THE INVENTION

The primary objective of the present invention is to provide an electric vehicle having a generator, which ensures that the electric vehicle is able to drive outdoors continually without causing any harmful effect to an electric machinery controller and a battery so as to provide a certain protection to the battery.

According to the present invention, there is provided an electric vehicle having a generator, comprising a body, an electric machinery, an electric machinery controller, a battery and a generator, the generator generating electricity to the battery and providing power supply to the electric machinery through the electric machinery controller for driving wheels of the body to advance, and characterized by: the electric vehicle further comprising a control system, the control system comprising a central processing unit (CPU), a battery voltage detection module to detect a voltage value of the battery and send the voltage value of the battery to the CPU, a comparison module to compare the voltage value of the battery with a preset maximum voltage value and a preset minimum voltage value and send a comparison result to the CPU, a battery output current detection module to detect an output current value of the battery and send the output current value of the battery to the CPU, a generator output voltage detection module to detect an output voltage value of the generator and send the output voltage valve of the generator to the CPU, the CPU being adapted to receive the aforesaid data and analyze for controlling the generator to work and its output status.

The present invention uses the control system to control the working and output status of the generator. The CPU makes relative judgments according to the detection result of each module and controls the generator to start relative modes. When the electricity of the battery is enough and the vehicle is not in a driving status, the generator will adopt a standard charging mode for the battery to be charged and maintained. When the vehicle is in a driving status, the CPU will detect the real output voltage and the output current of the battery to control the output voltage and the output current of the generator for ensuring that the electric machinery proceeds to work steadily so that the related parts will be protected to have a longer service life.

### BRIEF DESCRIPTION OF THE DRAWINGS

FIG. 1 is a schematic view showing a conventional direct current generator set for an electric vehicle;

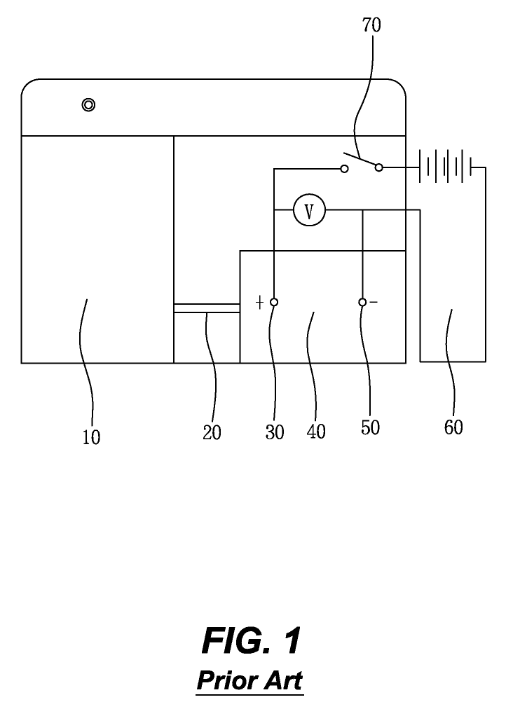

FIG. 2 is a schematic view of the present invention;

FIG. 3 is a diagram of the present invention; and

FIG. 4 is a flowchart of the present invention.

### DETAILED DESCRIPTION OF THE PREFERRED EMBODIMENT

Embodiments of the present invention will now be described, by way of example only, with reference to the accompanying drawings.

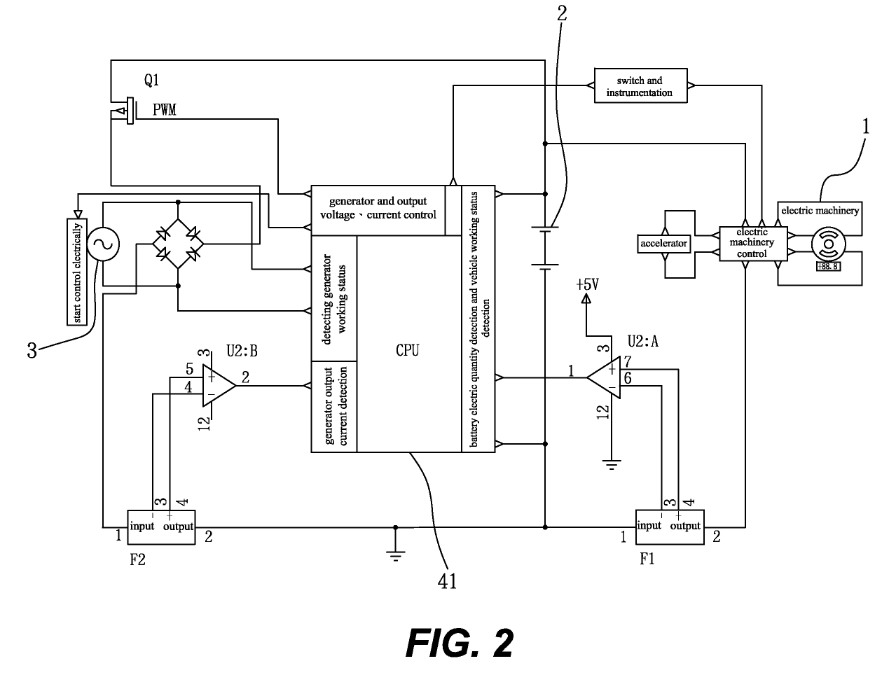

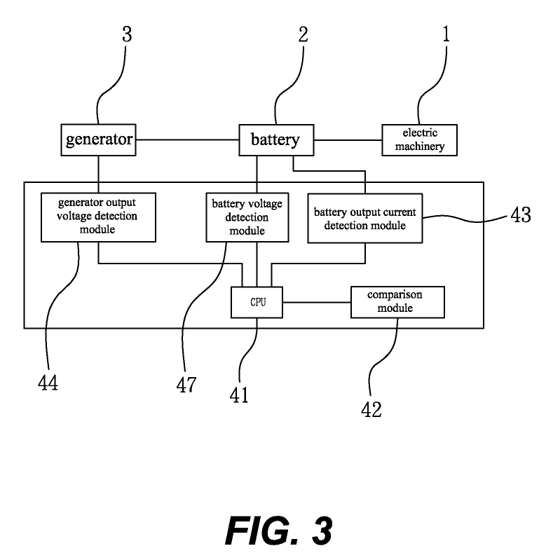

As shown in FIGS. 2 and 3, an electric vehicle having a generator of the present invention comprises a body (not shown in the drawings), an electric machinery 1, a battery 2, and a generator 3. The body coupled with wheels is driven by the wheels to advance. When the battery 2 is going to run out, the generator 3 will generate electricity to the battery 2. The battery 2 provides the power source to the electric machinery 1 for driving the wheels to keep the electric vehicle going. In this embodiment, the generator 3 is a common fuel generator, which generates alternating current. The alternating current must be rectified through a rectification circuit and then sent to the battery 2. This is a public technique and doesn't be described hereinafter.

The present invention further comprises a control system, as shown in the broken line of FIG. 3. The generator 3 may be operated manually or controlled by the control system according to different work modes for generating electricity to the battery 2, maintaining the battery 2, or providing power supply to the electric machinery 1. The control system comprises a central processing unit (CPU) 41, a comparison (signal collecting and processing) module 42, a battery output current detection module 43, a generator output voltage detection module 44, and a battery voltage detection module 47.

The battery voltage detection module 47 is connected to two ends of the battery 2 for detecting the real-time voltage of the battery 2. Because the real remnant electricity of the battery 2 is not easy to be detected directly, the real-time voltage of the battery 2 is adopted to monitor the remnant electricity of the battery 2. The battery voltage detection module 47 sends the detected output voltage of the battery 2 to the CPU 41.

The comparison module 42 is stored with two preset values. One is a minimum voltage value. When the output voltage value of the battery 2 is smaller than the minimum voltage value, the battery 2 needs to be charged. The other is a maximum voltage value. When the output voltage value of the battery 2 gets up to the maximum voltage value, the battery 2 is full and doesn't need to be charged. The CPU 41 sends the output voltage value from the battery voltage detection module 47 to the comparison module 42 for comparing it with one of the preset values, and then the comparison result to be sent to the CPU 41.

The battery output current detection module 43 is used to detect the output current value of the battery 2, referring to FIG. 2, which uses a shunt F1 and a direct current ammeter (not shown in the drawing, it is not a necessary). The detected output current value is also sent to the CPU 41.

The generator output voltage detection module 44 is used to detect the output voltage from both ends of the generator 3 and send the detected voltage value to the CPU 41.

The CPU 41 is the core part of the control system and used to analyze date and control each module. According to the comparison result of the comparison module 42 (if the voltage value of the battery 2 is smaller than the preset minimum voltage value, the generate 3 is started to charge electricity to the battery 2; if the voltage value of the battery 2 gets up to the preset maximum voltage value, the generate 3 is stopped to charge electricity to the battery 2), the output current value of the battery output current detection module 43 (if the current value is not zero, the electric vehicle is in a driving status, the output of the generator 3 is adjustable if necessary) and the output voltage value of the generator output voltage detection module 44 (if the voltage value is not zero, the generator 3 is in a working status), the CPU 41 controls the output voltage and the output current of the generator 3 for the battery 2 to be charged and maintained. There are two charging electricity modes. One is a standard charging program. The maximum output voltage and the maximum output current of the generator 3 are controlled by the CPU 41 for the battery 2 to be charged and maintained. The other is an auxiliary program. When the electric vehicle is driving and the electricity of the battery 2 is not enough, the CPU 41 will use PWM technique to adjust the output voltage and the output current of the generator 3 according to the rear-time voltage and the output current value of the battery 2 for insuring the safety of the battery 2 and providing stable power supply to the electric machinery 1.

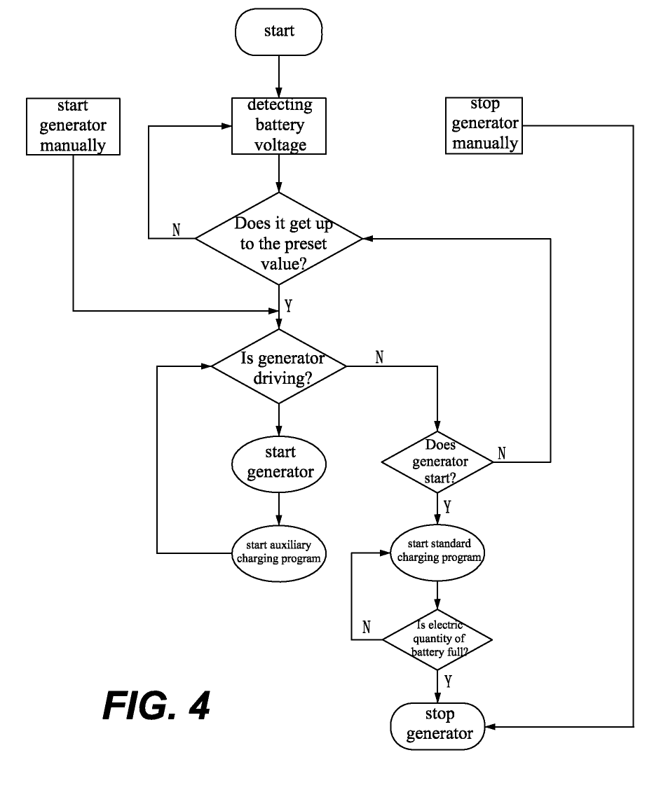

FIG. 4 is a flowchart of the present invention in use, which comprises the steps as follows:

(1) the battery voltage detection module 47 sends the detected output voltage value of the battery 2 to the CPU 41, the CPU 41 sends it to the comparison module 42 for comparing it with the preset minimum voltage value, the comparison result is sent to the CPU 41;

(2) the CPU 41 receives the comparison result, if the voltage value is larger than the preset minimum value, the remnant electricity of the battery 2 is enough, it is not necessary to start the generator 3 except manual operation and go to step (1) for proceeding with detection comparison, if the voltage value is smaller than the preset minimum value, it then proceeds step (3);

(3) the CPU 41 judges whether the output current value of the battery output current detection module 43 is zero for ascertaining the motion status of the electric vehicle, if the current is not zero, it indicates that the electric vehicle is in motion and then proceeds step (4), if the current is zero, it then proceeds step (6);

(4) the CPU 41 uses electricity to start the generator 3;

(5) the CPU 41 starts the auxiliary program when the voltage of the battery 2 is smaller than the preset minimum value and the electric vehicle is driving, the output voltage and the output current of the generator 3 is adjusted through a PWM regulated circuit for providing power supply to the electric machinery steadily along with the battery 2, thus, the electric machinery 1 is able to work steadily when the battery is going to run out, the CPU 41 controls the generator 3 to work in this mode all the time during the motion of the electric vehicle, the generator 3 may be controlled manually to stop working;

(6) if the electric vehicle is not in a driving status (the output value of the battery output current detection module 43 is zero), the CPU will judge whether the output voltage value of the generator output voltage detection module 44 is zero for ascertaining the working status of the generator 3, if the voltage value is zero, it indicates that the generator 3 has not been started and then goes to step (2), if the generator 3 is started manually at this time and the voltage value is not zero, it then proceeds step (7);

(7) the CPU 41 starts the standard charging program, the generator 3 is controlled by the CPU 41 for outputting charging voltage and charging current to the battery 2;

(8) the CPU 41 sends the voltage value from the battery voltage detection module 47 to the comparison module 42 for comparing it with the preset maximum voltage value to judge whether the electricity of the battery 2 is full, if not yet, it then goes to step (7) for the battery 2 to be charged continually, if the electricity of the battery 2 is full, it then proceeds step (9); and

(9) the CPU 41 controls the generator 3 to stop working, the generator 3 may be stopped manually.

The electric vehicle having the generator 3 of the present invention uses the special control system. According to the real wording status of the electric vehicle, the generator 3 is set with different working modes for the battery 2 to be charged or maintained through a special PWM control technique or for providing power supply to the electric machinery 1. When the electric vehicle is driving and its electricity is not enough, the CPU 41 will detect the real output voltage and the output current of the battery 2 to control the output voltage and the output current of the generator 3 for ensuring that the electric machinery proceeds to work steadily so that the related parts will be protected to have a longer service life.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electric vehicle having a generator, comprising a body, an electric machinery, an electric machinery controller, a battery and a generator, the generator generating electricity to the battery and providing power supply to the electric machinery through the electric machinery controller for driving wheels of the body to advance, and characterized by: the electric vehicle further comprising a control system, the control system comprising a central processing unit (CPU), a battery voltage detection module to detect a voltage value of the battery and send the voltage value of the battery to the CPU, a comparison module to compare the voltage value of the battery with a preset maximum voltage value and a preset minimum voltage value and send a comparison result to the CPU, a battery output current detection module to detect an output current value of the battery and send the output current value of the battery to the CPU, a generator output voltage detection module to detect an output voltage value of the generator and send the output voltage valve of the generator to the CPU, the CPU being adapted to receive the aforesaid data and analyze for controlling the generator to work and its output status.
